(19) United States
(12) Patent Application Publication
(10) Pub. No.: US 2009/0164378 A1
(43) Pub. Date: Jun. 25, 2009

(54) Music Distribution

(76) Inventors: Steven Marcus Jason West, Auckland (NZ); Edouard Malachi Poor, Auckland (NZ)

Correspondence Address: DANN, DORFMAN, HERRELL & SKILLMAN, 1601 MARKET STREET, SUITE 2400, PHILADELPHIA, PA, 19103-2307, US

(21) Appl. No.: 11/962,360

(22) Filed: Dec. 21, 2007

(51) Int. Cl. G06Q 10/00; H04L 9/32

(52) U.S. Cl. 705/55; 705/51

(57) ABSTRACT

The present invention relates to a method of distributing music comprising creating a structured audio file from an audio track, the audio track having two portions, the first portion comprising data to reproduce a lower quality version of the audio track by a media player and data in a second portion that can be used to reproduce a higher quality version of the audio track.

### FIELD OF THE INVENTION

The present invention relates to an audio file format and associated system, method and/or software for distributing music. The invention relates to music encoded in a digital format, such as MP3, WAV, AAC or the like.

### BACKGROUND TO THE INVENTION

Over the last few years the advent of digital audio file formats for storing and transmitting music digitally has enabled the transmission of music more readily over the internet and via other digital means. This has made the distribution of music among listeners an easy task. M

Music distributors (such as record labels/recording companies) have traditionally distributed promotional music to DJs and other industry critics to receive feedback on the music prior to full production and marketing of the music to the general public. Traditionally, the music was distributed by way of free CDs, tapes and vinyl records. The nature of traditional music formats meant that this practice was acceptable to record labels, as it was difficult for illegitimate copies of the promotional music to be widely distributed to the general public. However, because distribution of digital audio file formats is relatively easy, music distributors of late have been reluctant to release promotional music to DJs/music critics in these formats. The risk of inadvertent/illegal re-distribution by the DJs/critics is too great, thus risking reduced profits if and when the music in question is released commercially in the normal manner.

### SUMMARY OF THE INVENTION

It is an object of the present invention to provide for improved music distribution.

In one aspect the present invention may be said to consist in a method of distributing music comprising the steps of:

creating a structured audio file from an audio track, the structured audio file having an audio file format that comprises a non-audio portion and an audio portion, wherein the format is recognisable by a standard media player such that the audio portion is reproducible by a standard media player, the structured audio file comprising:
first data in the audio portion that can be used to reproduce a lower quality version of the audio track by a media player, and
encrypted second data in the non-audio portion that can be used to reproduce a higher quality version of the audio track,

and

wherein the structured audio file is for provision to one or more users having a media player adapted to extract and decrypt the encrypted second data and adapted to reproduce the higher quality version of the audio track from the second data.

Preferably, the non-audio portion of the structured audio file is a metadata portion.

Preferably, the media player is adapted to extract and decrypt the encrypted second data by way of having the requisite permissions.

Preferably, the media player is adapted to extract and decrypt the encrypted second data by way of being operated by a user with requisite permissions.

Preferably, the media player is adapted to extract and decrypt the encrypted second data by way of having the requisite permissions and being operated by a user with requisite permissions.

Preferably, the media player has requisite permissions by having one or more keys for decryption.

Preferably, the user has requisite permissions by having a password that can be supplied the media player.

Preferably, the method further comprises receiving the audio track from a third party.

Preferably, one or more of the steps could be conducted on hardware at different locations and/or operated by different entities.

Preferably, the method further comprises providing the structured audio file to one or more users having a media player adapted to extract and decrypt the encrypted second data and adapted to reproduce the higher quality version of the audio track from the second data.

Preferably, the audio track is a promotional audio track.

Preferably, the method further comprises the step of receiving data from one or more media players of one or more users, the data representing information relating to playback of the audio track.

Preferably, creating the structured audio file comprises the steps of:

converting the audio track into first data using an encoding regime, the first data defining the audio track in a manner such that the audio track will be reproduced at a lower audio quality by a media player, and

converting the audio track into second data using an encoding regime, the second data defining the audio track in a manner such that the audio track will be reproduced at a higher audio quality by a media player if permission exists, and

encrypting the second data.

Preferably, the structured audio file further comprises an authorised list of users and/or players and/or player types.

Preferably, the encrypted second data comprises a watermark.

Preferably, the structured audio file format is an MP3 format.

Preferably, the audio track is originates from one or more of a/an:

music distributor,

recording company,

record label, and/or

artist.

Preferably, providing the structured audio file comprises providing the file for download by one or more users having a nominated media player adapted to extract and decrypt the second data and adapted to reproduce the higher quality version of the audio track from the second data.

Preferably, a media player not adapted to extract and decrypt the encrypted second data can reproduce a lower quality version of the audio track using the first data in the audio portion.

Preferably, a method further comprising the steps of:

downloading the structured audio file to a media player,

obtaining a decryption key and decrypting the encrypted second data, and

reproducing a higher quality version of the audio track from the second data.

Preferably the method further comprises the steps of:

downloading the structured audio file, and

reproducing a lower quality version of the audio track from the first data using a media player.

Preferably, the method is carried out by one or a combination of:

music distributor,

recording company,

record label,

music provider, and/or

third party service.

In another aspect the present invention may be said to consist in a method of creating a structured audio file for distribution comprising the steps of:

converting an audio track into first data using an encoding regime, the first data defining the audio track in a manner such that the audio track will be reproduced at a lower audio quality by a standard media player, and

converting the audio track into second data using an encoding regime, the second data defining the audio track in a manner such that the audio track will be reproduced at a higher audio quality,

encrypting the second data,

creating a structured audio file having a format that is recognisable by a standard media player, the structured audio file having a non-audio portion comprising the encrypted second data and an audio portion comprising the first data.

In another aspect the present invention may be said to consist in an apparatus for distributing music, the apparatus being adapted to:

create a structured audio file from an audio track, the structured audio file having a format that comprises a non-audio portion and an audio portion, wherein the format is recognisable by a standard media player such that the audio portion is reproducible by a standard media player, the structured audio file comprising:
first data in the audio portion that can be used to reproduce a lower quality version of the audio track by a media player, and
encrypted second data in the non-audio portion that can be used to reproduce a higher quality version of the audio track,

and

wherein the structured audio file is for provision to one or more users having a media player adapted to extract and decrypt the encrypted second data and adapted to reproduce the higher quality version of the audio track from the second data.

Preferably, the apparatus comprises hardware at different locations and/or operated by different entities.

In another aspect the present invention may be said to consist in a structured audio file embodying an audio track for distribution, the file having a format that is recognisable by a standard media player and comprising:

an audio portion comprising first data, the first data obtained by converting the audio track using an encoding regime, the first data defining the audio track in a manner such that the audio track will be reproduced at a lower audio quality by a standard media player, and

a non-audio portion comprising encrypted second data, the second data obtained by converting the audio track using an encoding regime, the second data defining the audio track in a manner such that the audio track will be reproduced at a higher audio quality.

In another aspect the present invention may be said to consist in a method of distributing music comprising a structured audio file comprising an unencrypted low quality audio track in an audio portion and an encrypted high quality audio track in a non-audio portion.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

The term “comprising” as used in this specification means “consisting at least in part of”. Related terms such as “comprise” and “comprised” are to be interpreted in the same manner.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

### BRIEF LIST OF FIGURES

Preferred embodiments of the invention will be described with reference to the following figures, of which:

FIG. 1 is a block diagram of an overview of the invention for distributing music,

FIGS. 2a, 2b are flow diagrams showing a method of distributing music,

FIG. 3 is a block diagram of one embodiment of a system/method for distributing music,

FIGS. 4a, 4b are schematic diagrams of an audio file format in accordance with one embodiment of the present invention,

FIG. 5 is a block diagram of the encoding server,

FIG. 6 is a block diagram of the audio track download process, and

FIGS. 7a, 7b are schematic diagrams of a structured audio file in MP3 file format.

### DETAILED DESCRIPTION OF PREFERRED EMBODIMENTS

### Overview

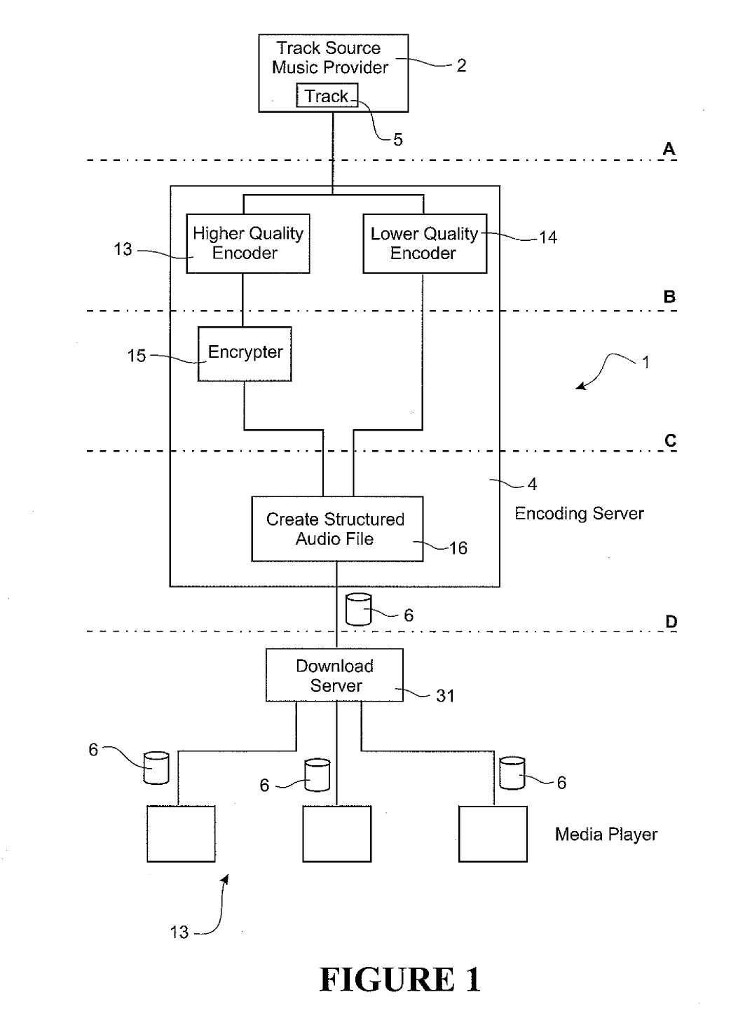

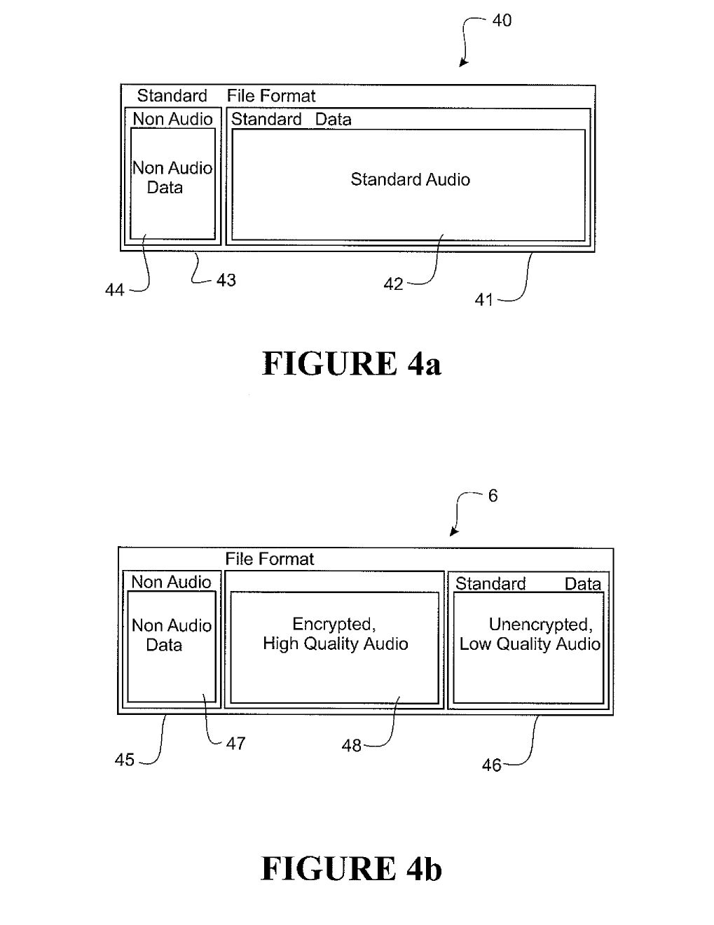

FIG. 1 shows a general overview of the present invention 1. The present invention relates to a method of distributing music, and also a system and software for distributing music. The present invention comprises or utilises a structured audio file 6 (see FIG. 4b) that facilitates distribution in the desired manner. The structured audio file 6 is in a digital audio file format. Preferably, the method, system and software are used for the distribution of promotional music or other music, which is to be released in a controlled or limited manner to a select group of people. This is done for the purpose of maintaining options for full commercial exploitation of the music at a later stage.

FIG. 1 shows a system 1 that can be used to implement the method of the present invention. The system 1 embodies the software and structured audio files that facilitate the method. The system 1 shown contains a number of components that are typically remotely distributed.

Referring to FIG. 1, the invention allows a range of music providers 2 to provide music to over a network 3, such as the internet, to end users. A source audio track 5 is used to create the structured audio file 6 that can be downloaded and used by media players to play the music. The source audio track 5 originates from a track source or music provider 2. The music provider 2 may, for example, be an artist, record label, recording company, music distributor or other source of music. The source audio tracks 5 are each embodied in a digital audio file, encoded according to a digital audio format. Each digital audio file comprises data that specifies/defines a song or other audio content (that is, an audio track). The digital audio file will more generally be referred to as an “audio track”, being the audio content that it embodies.

An encoding server 4 takes the source audio track 5 and implements encoding processes 13, 14 to create a high quality version 13 of the audio track, and a low quality version 14 of the audio track 5. The encoding server 4 also operates a process 15 to encrypt the high quality version of the audio track. The encoding server 4 then operates a process 16 to combine the higher and lower quality versions of the tracks, along with other metadata information from the track source/music provider 2 to create the structured audio file 6. This is then passed to a download server 31, which can provide the structured audio file 6 for download for transfer to media players 13. Media players with the required permissions, and/or that are operated by permitted users can play back the higher quality version of the audio track using the data in the structured audio file 6. Media players that are not authorised and/or are not being operated by an authorised player can only play back the lower quality version of the audio track using the data in the structured audio file 6. They might also not play the track at all.

This process can happen for each of a large number of audio tracks 5, from each of a number of music providers 2.

The encoding server 4 and the processes implemented by the encoding server can occur in a single location in hardware, or can occur/reside in multiple locations, distributed remotely over hardware operated by one or more entities.

For example, referring to reference D, the encoding server 4 and its processes could be operated entirely by the music provider 2. The music provider would then pass the structured audio file 6 on to the download server 31 to distribute the track. The music provider 2 might even operate the download server 31. Alternatively, reference C, the music provider 2 could operate the encoding server/processes 13, 14, 15, 16 that create the higher and lower quality versions of the audio track, and encrypt the higher quality version. This data could then be distributed to a remote third party, which would create the structured audio file 6, and operate the download server 31, or provide the structured audio file to a download server. The third party could provide/be a hosting and/or distribution service.

Yet alternatively, reference B, the music provider 2 might only encode 13, 14 the high and load quality versions of the audio track, and pass these to the third party for further processing 15, 16. Alternatively, the encoding server might be entirely operated by the third party, who would carry out all the processes 13-16. They would receive the audio track 5 from the music provider 2.

There is a benefit in retaining as much of the processing as possible with the music provider. This reduces the amount of data that needs to be distributed. The encoded higher quality/lower quality tracks and the structured audio files require less data than the high quality source file. It can be desirable, although not essential, that this large source track is not transmitted to a third party. This must be weighed against the cost and convenience of having the processing carried out remotely.

A range of encoding servers/processes might be employed for a range of music providers, each configured and operated in one or the ways mentioned above. The configuration of the encoding server/processes will depend on the resources and requirements of each of the music providers.

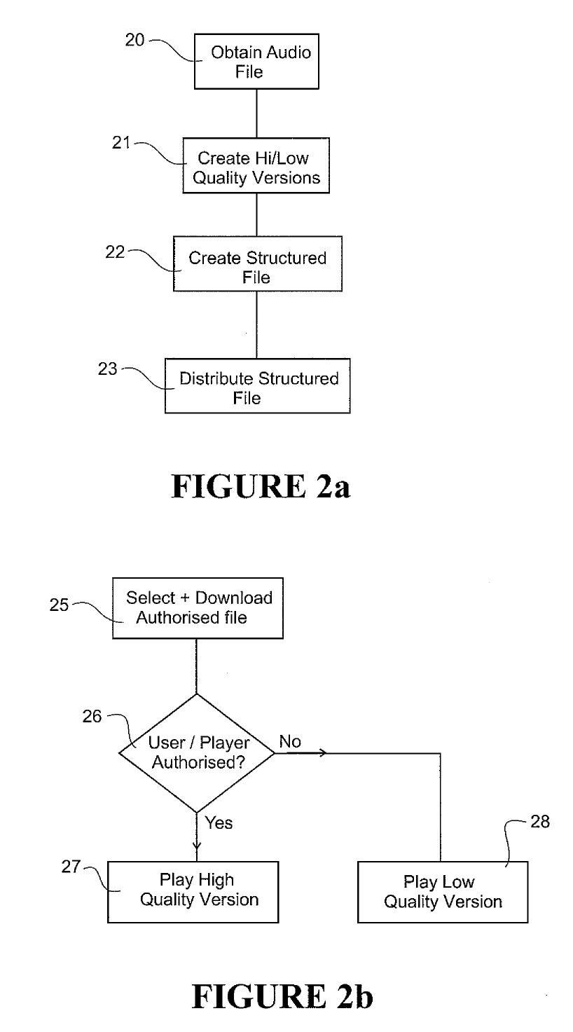

FIGS. 2a, 2b show an overview of a music distribution method according to one embodiment. This could be implemented in a single location or multiple locations as mentioned above. An audio file is obtained, step 20, and then high and low quality versions of the audio track are created, step 21. The high quality version is also encrypted. A structured audio file is created from the two versions, and other information, step 22. This file is then passed to a server for download distribution, step 23. Referring to FIG. 2b, a permitted user can enter their ID details into a media player. The media player can then receive a structured audio file, step 25, either by direct download over the internet, or via some other method. If the user (and/or the player if necessary) is authorised, step 26, the media player will play a higher quality version of the audio track embodied in the structured audio file, step 27. If the user (and/or player if necessary) are not authorised, step 26, then the player plays back the lower quality version of the audio track, step 28 (or might not play anything at all). Multiple structured audio files can be downloaded as required. Note, there might be two authorisations, one to allow access to the internet site for download, and another to allow play back of the higher quality version. These authorisations could be integrated or separate.

Each music provider can stipulate for each track what the requirements are for playing the high quality version of the audio track. This might be that the user has to be authorised, or that the player has to be authorised, or that both have to be authorised. Therefore, each track a user downloads might have different restrictions, meaning the media player can play back higher quality versions of some downloaded tracks, but only lower quality versions of other downloaded tracks. It might not play anything at all if it doesn't have the required permissions.

### One Embodiment

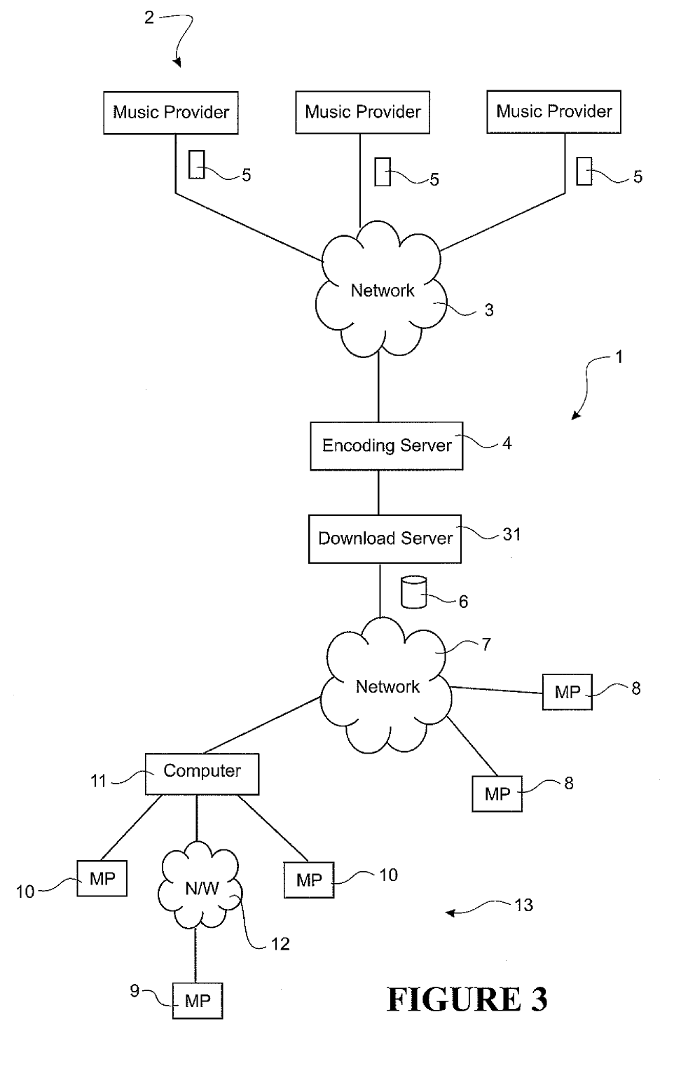

FIG. 3 shows one possible embodiment, where the encoding server/processes are operated entirely by a third party. From here, the description will describe the invention in relation to one audio track and how it is distributed. It will be appreciated that the system can process and distribute a large number of audio tracks received from a large number of music providers. Each audio track can be processed/distributed in the same manner, as described below.

A number of music providers 2 form the system, each providing source audio tracks 5. The encoding server 4 receives the source audio track 5 form a music provider 5 and converts it into a structured audio file 6 suitable for distribution. This file is described in relation to FIGS. 4a, 4b. The structured audio file 6 is generated from the audio track 5 and among other things contains data for reproducing two versions of the audio track, a higher quality version and a lower quality version. Once created, the structured audio file 6 can be provided to a download server 31 for download via a network 7 (such as the internet) to a number of media players 8-10. The media players 8 may have integrated download/internet capability (such as a computer which also executes media player software). These media players can connect to the internet and directly receive the distributed audio track for reproduction. Other media players 9, 10 might be dedicated players that have no internet download capability. These can receive audio tracks distributed via the system indirectly from a download/internet capable machine 11. This could be by way of direct connection to the machine 10, or via some network 12.

The media players (from now on generally referred to as 13) can take the structured audio file 6 and extract the data to at least play the lower quality version of the audio track. Media players 13 that have the requisite permissions can also use their structured audio file to play a higher quality version of the audio track. The term “play” means that the media player extracts the data embodying the audio track and reproduces a rendition of that audio track through its speakers, headphones or other audio output means.

For clarity, when referring to the audio track, the specification is referring to the audio track that the music provider uploads to the system. A lower or higher quality version of the audio track might technically be a different audio track. However, it will be appreciated that generally speaking a reference to a higher or lower quality version of the audio track is a reference to the same content (such as song) embodied in the music provider's audio track, notwithstanding that it might have a different level of fidelity on playback.

Once downloaded, the structured audio file can be distributed further from the initial media player 13 to other media players. It can be distributed to other media players 13 via any suitable means, such as direct or wireless connection, network or via a storage device. Where the structured audio file 6 is transferred to another media player 13 that does not have the requisite permissions, that other media player 13 can utilise the structured audio file to play the lower quality version of the audio track. Where the structured audio file 6 is transferred to another media player 13 that does have the requisite permissions, that further media player 13 can play the higher quality version of the audio track from the structured audio file 6. Once the audio track is played by a media player, data can be sent from the individual media player indicating information regarding the audio track, such as when it was played. This can be sent back to the music provider, via the distribution service.

The general nature of the structured audio file 6 will be described with reference to FIGS. 4a, 4b. FIG. 4a shows in schematic form the structure of an existing digital audio file 40 that is in a typical audio digital file format. Such a digital audio file comprises data that embodies an audio track and can be recognised by a standard media player and used to play that audio track. The digital audio file comprises an audio portion 41, which comprises audio data 42 specifying/defining the audio track. The audio track will be encoded according to some digital audio format, such as WAV, MP3, AAC or the like. The audio data represents the track in this encoded format. The digital audio file also comprises a non-audio portion, that comprises other data. This non-audio portion could for example be a metadata portion 43, that comprises information or metadata 44 specifying auxiliary information. In many formats, the metadata portion has a number of “containers” in which metadata is stored in or separated into. These containers can take the form of “tags”, such as those known in the MP3 format. This information/metadata provides information on the audio track itself, such as title, artist, album, genre, length and the like.

FIG. 4b shows a structured audio file 6 in accordance with the present invention. It also comprises non-audio 45 and audio portions 46. The format can be recognised by a standard media player. However, the audio portion comprises audio data 46 that specifies the audio track in a lower quality version. Again, the audio track can be encoded in some digital audio format and the data represents the track in this encoded format. The lower quality version can be created in any suitable way. For example, the lower quality might be created by encoding the track using a low-fidelity encoding scheme. Other manners in which to create lower quality versions are also possible. For example, the data might be stored, or track encoded in a manner that prevents a media player playing the audio track at a higher quality, even if the information is available to play at a higher quality. Data is stored such that when a media player plays the audio track embodied by the data, it plays a lower quality version of the audio track. The invention should not be limited to the means in which the track is defined in order to achieve this ends.

In FIG. 4b, the non-audio portion 45 comprises the usual information 47. But it also comprises data specifying a higher quality version of the audio track 48, encoded in some digital audio format. For example, if the non-audio portion is a metadata portion, this data defining the higher quality version might be stored in a container or tag, if the audio format supports such a structure in the metadata portions. By “higher quality version of the audio track”, it is meant that a media player (permission dependent) can use the audio data representing the higher quality version to reproduce a version/rendition of the audio track that is higher in quality (to the end user's ears) than can be reproduced by the media player using the audio data representing the lower quality version of the audio track. Note, the higher quality version of the audio track when reproduced might not be as higher quality as the original audio track. Again, the audio data represents the audio track in a way that enables a permitted media player to render the track at the higher quality. This might be obtained in any number of ways, such as encoding the audio track with a higher quality encoding scheme and/or higher bit rate than that for the lower quality version of the audio track. Other methods could be used also. The audio data specifying the higher quality version of the audio track is also encrypted. Only media players that have access to the decryption keys can extract and play the data.

The phrase “lower quality version” refers to anything that will be perceived by an end user as lower quality upon listening to the version in playback. For example, the quality will be such that an end user will find that the lower quality version does not provide as much aural enjoyment/quality as a higher quality version. The lower quality track could meet this by having perceived low fidelity. Optionally, it might also comprise the track having normal or low fidelity and being truncated in length. Similarly, “higher quality version” refers to anything that will be perceived by an end user as higher quality upon listening to the version in playback. The end user will find it provides more aural enjoyment/quality than the lower quality version upon playback. The higher/lower quality terms do not necessarily specify the quality of the track as stored, or the data storing it. Rather, it refers to the end user perception of those stored tracks once played, irrespective of how that higher/lower quality might be achieved.

The structured audio file could be provided in any suitable audio file format, for example WAV, AAC, MP3 or the like. It will be appreciated that an audio file in a particular audio file format, such as MP3, will for the lower quality version of the audio track, store audio data encoded according to the encoding scheme for that format. Audio data defining the higher quality version of the audio track can be encoded according to any suitable encoding scheme that provides the required level of quality. The audio file will also have particular features/specifications relating to the data, specified by the standard. For example, an audio file in the MP3 file format will, among other things, have audio data embodying a track encoded according to the MP3 standard.

It will be appreciated that the system 1 could be considered to comprise the music providers 2, networks 3, 7; encoding server 4, download server 31, and media players 13, or alternatively, some subset of them. For example, the system might be considered just to be the encoding server 4, with the other aspects being connected to the system. Some or all of the encoding processes/server could be distributed among some or all of the music providers, as appropriate.

The system 1 depicted generally in FIG. 1 to 4b enables distribution of audio tracks 5 by music providers 2, while still providing them with some control over the audio track so as to retain options for later commercial exploitation. For example, a music provider might wish to provide a promotional audio track for use by DJs utilising a specific player to gauge general acceptance of the audio track. By releasing the audio track via the present invention, the music provider can gauge acceptance of the track, but still retain the ability to release a full commercial version of the track to a wider audience at a later date, without the commercial market for that track being destroyed by the promotional version being distributed illegitimately. Releasing the lower quality version still allows a permitted user to preview and organise their tracks, even if they can't use a permitted media player, or for some other reason. This means the tracks are still useful to them. Distributing only an encrypted higher quality version of the track might inconvenience users, who in some circumstances are permitted to use the higher quality version. This reduces the acceptance of such a distribution system.

### Encoding Server

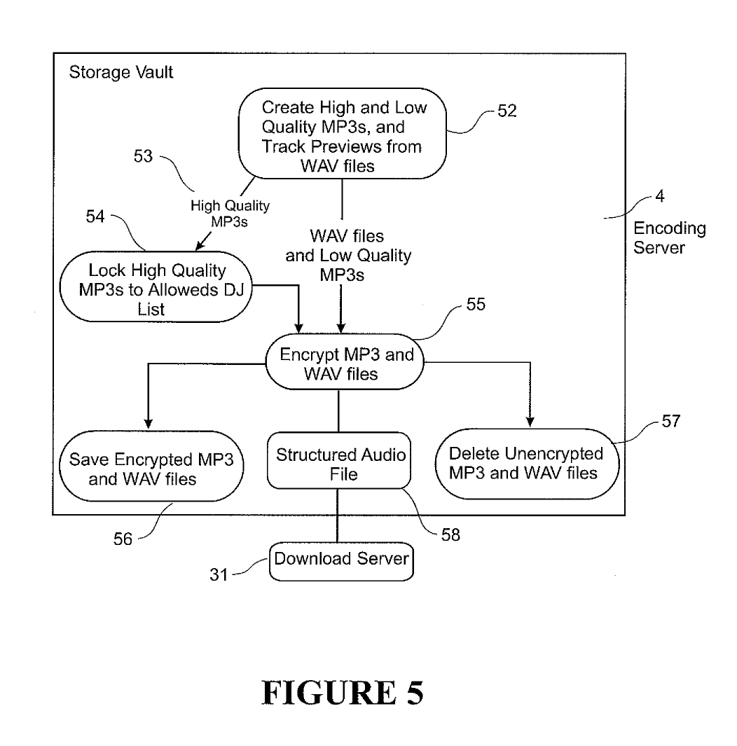

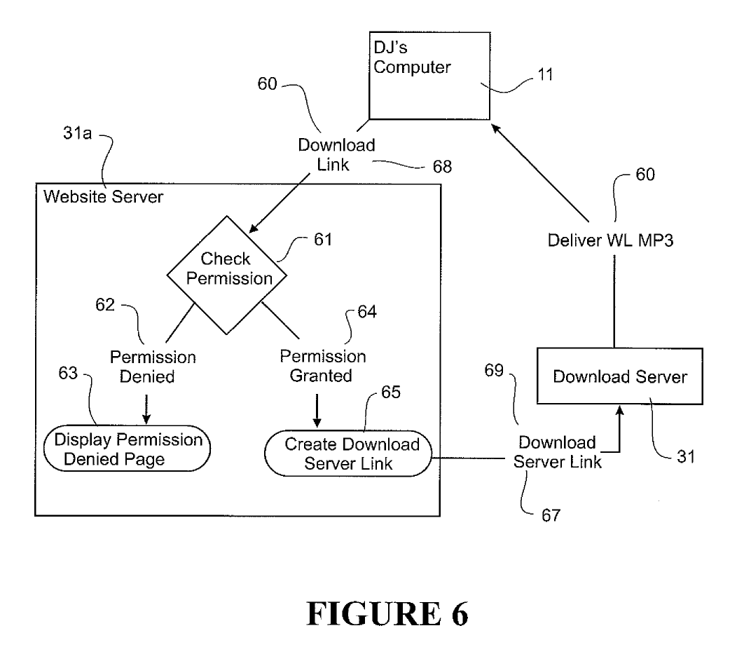

FIGS. 5, 6 show one possible embodiment of the encoding server and its operation. FIG. 5 shows in further detail how the audio track is received and then processed to generate a structured audio file 6 that can be distributed according to a method of the present invention. The following description will relate to a single music provider and track, for clarity. It will be appreciated that any particular music provider could upload a number of audio tracks each for conversion and distribution in accordance with the invention.

The music provider uploads the audio track in a suitable high quality file format such as a WAV format, along with any other required or desirable information such as artwork, track descriptions and the like. The music provider 2 also uploads information, called ACL (access contro list) data, identifying particular users (or their media players) that are allowed access to (that is, listen to) a higher quality reproduction of the audio track. For example, this information could be in the form of an allowed DJs list which provides a list of DJs that should be able to listen to a higher quality version of the track. Where a music label is distributing a promotional audio track, this would be the DJs who the music provider wishes to have access to high quality version of the promotional track in order to receive feedback. The music provider would want to restrict other people's access to the higher quality version of the audio track.

The encoding server then utilises the information to create the higher and lower quality versions of the audio track from the WAV file, step 52. In doing so it creates the audio data representing the audio track in the two different fidelity levels. From here, use of the phrases “higher/lower quality versions of the audio track” can also be taken to refer to the underlying audio data that represents/embodies those versions of the audio track, and which can be used by a media player to reproduce various renditions of the audio track. Preferably, it creates them by using the MP3 encoding regime to create an MP3 encoded version of the track. Other encoding schemes could be used. The encoding server might also create a preview track from the WAV file for use on a website, if desired.

The higher quality version is then optionally provided with a watermark. The watermarking step, which is optional, provides some degree of protection against the user rerecording a high quality version of their audio track directly from an analogue output of their media player. The audio watermarking system marks each downloaded track with a unique ID that corresponds or correlates the track to the user who downloaded it. This information is stored in a database each time the structured audio file is downloaded. Any suitable watermarking system could be used. In one possibility, MP3 bit streams are watermarked after encoding, therefore avoiding loss of fidelity associated with post-watermarking compression.

The watermarking method embeds an imperceptible unique identifier into each audio file forming the structured audio file during download. The watermark can be detected even if the file has undergone an analogue step and/or has been re-encoded as a new MP3 or other digital format.

The encoding server 4 then locks or couples the higher quality versions of the audio track to the data contained within the ACL (e.g. the allowed DJs list), step 53. This creates a table or database 54, of audio tracks, each being correlated to particular users that are authorized to listen to the higher quality version of the audio tracks.

During the creation process, the server chooses a key with which to encrypt the higher quality version of the audio track, possibly from a roster of random keys. The higher quality version of the audio track is encrypted with the encryption key, step 55, and stored in a storage facility, step 56. The WAV file for the audio track is also encrypted, possibly with a different key, and stored in the storage facility, step 6. The unencrypted versions of the higher and lower quality audio tracks, along with the WAV file of the source audio track, are deleted, step 57, leaving no unencrypted versions of the audio track on the encoding server or storage facility.

The structured audio file 6 is then created from the higher and lower quality versions of the audio track, step 58, and then passed to the download server 31.

More particularly, a user who wants to listen to the audio track obtains it, as shown in FIG. 5. The user accesses the download server using a computer or any other suitable equipment for receiving downloads over the internet or other network. As noted earlier, the computer 11 might contain a media player for reproducing the audio track from the downloaded data, or the data might be transferred to such a player via a suitable means for reproductions of the audio track. The download server itself might be associated with a website server 31a to assist the download process. This enables the user to view and select desired tracks for download. The user first accesses the website server 31a and searches for the audio track they wish to obtain, step 60. They may listen to a streamed preview of the track to assist their selection. The download server 31 will contain a large number of digital audio files corresponding audio tracks supplied by one or more music providers 2. All the audio tracks will have been created in the manner described previously. Upon selecting a track, the user the website server 31a provides a download link 68, step 60, to receive the structured audio file corresponding to the desired audio track. The download link 68 points to the website server, which checks, step 61, that the user has permission to download a structured audio file embodying the audio track in higher and lower quality versions. More particularly, the user will identify themselves to the website server in a suitable way, for example by entering a password and user code. The identification data is transferred to the website server 31a, which compares the information against the ACL data (allowed users list) that is stored in the website server 31a.

If the website server 31a cannot match the user identification data against a permitted user in the ACL data, step 61, then it will determine that the user requesting the audio track does not have permission to receive and listen to that audio track, step 62. The website server will return a notification to the user that they are not permitted to obtain the track, step 63. If the website server 31 a determines, step 61, that the identification data relates to a user that is permitted to listen to the audio track relating to the download link, step 64, then the website server will create a download server link 67, step 55, which is transferred, step 69, to the download server 31. The user can follow this download server link 69. Access is also checked, when the user follows the website server link 68 and when they are redirected to the download server 31. This multiple access check means that a user that is not on the permitted users list cannot use a link obtained from another user who is on the permitted users list. Neither a download link 68 on the website server 31a, nor a download server link 69 will work for a user who is not on the allowed users list.

If the user is not on the allowed users list then permission to obtain the track is denied, and notification of this is provided to the user. If the user is on the allowed user's list, and follows the download server link 69, then the download server 31 sends the structured audio file to the user, over the internet or other suitable network 7 to the user's computer 11.

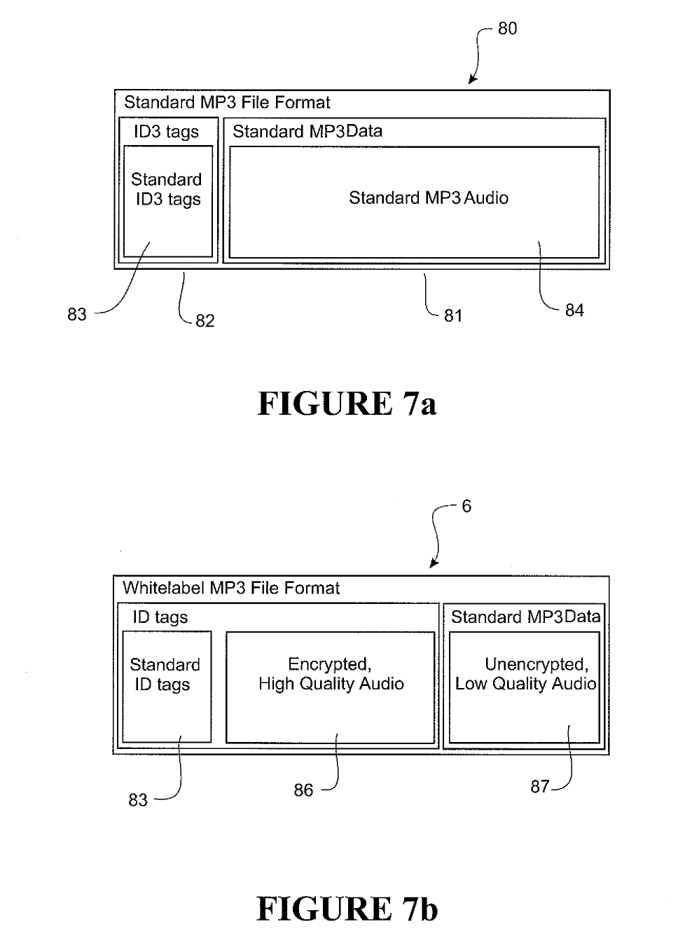

The structured audio file is in a MP3 file format. This will be described with reference to FIGS. 7a, 7b. The MP3 file format is one instance of the generic file format provided in relation to FIGS. 2a, 2b.

FIG. 7a shows a typical MP3 file format, with a tag (metadata) portion 82 comprising a number of ID3 tags 83 for holding auxiliary information. Strictly speaking, the ID3 standard specifies the metadata portion as a tag, and the containers within the tag as frames. However, the frames themselves are commonly referred to as tags, as is done in this specification. The file format also comprises an audio data portion 81 comprising audio data 84 defining an MP3 encoded audio track. FIG. 7b shows the structured audio file according to the present invention, based on the MP3 file format. In addition to the standard ID3 tags 83, the structure audio file comprises encrypted audio data 86 defining the higher quality version of the audio track (encoded as an MP3) embedded in an ID3 tag. It also comprises the unencrypted data 87 defining the lower quality version of the audio track (encoded as an MP3) embedded in the audio portion 81 of the structured audio file 6. The track descriptions, artwork and other auxiliary information are also embedded as tags in the tag portion 83 as appropriate. The higher quality version is provided with enough fidelity such that the track can be used and listened to in the normal manner. The lower quality version is of a quality that can be listened to, although is of a quality that is less desirable to listen to, and would ordinarily not be an acceptable quality for normal listening. A person who wished to listen to the track in the normal manner would more desirably try to obtain a higher quality version of the track. For example, the high quality audio could be encoded at 320 kilobit per second stereo MP3, and the low quality audio is encoded at 32 kilobits per second mono MP3. The file can then be delivered, step 60, as described previously.

The structured audio file also contains information that allows the media player to determine the matching decryption key that can be used to decrypt the higher quality audio track. If an ACL was used in the creation of the structured audio file, the file also contains information that the media player can use to determine the user or users that are authorized to play back the track, after those users have supplied the media player with their usernames and passwords.

The user and/or the media player itself my require permission to play the track. For example, the higher quality version of the track might be playable if the user is authorised. This means an authorised user could play the track on any compatible media player. Alternatively, it might be the media player that is authorised, meaning that any user using that media player can play a higher quality version of the track. Yet alternatively, it might be necessary that both the user and the media player are permitted/authorised to play the higher quality version of the track. An authorised media player can be termed a nominated media player. A particular media player might be a nominated media player. Alternatively, a brand, type or class of media player could be a nominated media player. A media player might be authorised by connection to a particular piece of hardware, such as a dongle. Also, a media player could be authorised by a user password.

Once the computer receives the download structured audio file 6, it can be passed to the media player. If there are the requisite permissions, the media player can obtain the key, decrypt the audio data 86 representing the higher quality version embedded in the ID3 tag, and play a higher quality version of the audio track. If there are not the requisite permissions, then the media play can play only a lower quality version of the audio track, by using the unencrypted audio data 87 in the data portion 81 of the structured audio file 6. If the structured audio file is transferred to another media player, the same process occurs. The other media player can only play the higher quality version of the audio track if it (or the user) has the requisite permissions.

Music providers can use the system and method to control distribution of their music. A service provider can operate the distribution server to receive, process and distribute audio tracks in accordance with the method. The service provider could charge a subscription or service fee to provide the service.

### Further Embodiment

In a preferred embodiment, the method and system is used in relation to a digital file/vinyl record DJ playback system, more generally a vinyl based digital file controller. Such a system comprises hardware with an audio card and software on a computer that enables a DJ to use specially encoded vinyl discs playing on standard turntables to “play” MP3 or other digitally recorded files stored on a computer or other storage system. The computer usually has internet access. The playback of the MP3 or other track correlates directly to the position of the turntable needle on the encoded vinyl disc. In effect, it appears as though the MP3 is playing from the vinyl disc. The software is a media player that can receive stored tracks and reproduce those tracks from the stored data for playback.

The system and method according to the first embodiment can be utilised in relation to such a system. In this case only vinyl based digital file controllers that have the required software will enable permitted users to access and reproduce the higher quality versions from a structured audio file. The permitted user using another type of media player, or a non-permitted user using the vinyl based digital file controller would not have access to the higher quality versions of the audio track. In this way music providers could restrict access to permitted users, and only permit reproduction of the track using the scratch live media player. If another user wanted to listen to the track or reproduce on a media player, or the permitted users to reproduce the audio track on another media player, they would only be able to do so with the lower quality version of the MP3.

More generally, the user of the vinyl based digital file controller will use the computer part of the system to access the website server to obtain an audio track for play on the system. They have a username and password for using the service, which they enter into the system via a user interface. This allows logon to the music distribution server, and it also authorises playback on the vinyl based digital file controller system.

Using the software the permitted user downloads the structured audio file for the desired audio track. The system software contains the ability to decrypt the higher quality audio track based on the information stored within the structured audio file. The system software also contains functions to determine whether the username and password supplied by the user allow the authorization to play back the higher quality version of the audio track. If the username and password do not allow such authorization, the system software will not play back the higher quality audio track, but may refuse to load and play the track, or may only allow play back of the lower quality audio track.

The software contains the code required to recognise and communicate with the system hardware. The playback controls are only accessible in software when the hardware is connected. This restricts play of the higher quality version to permitted users, using this particular system (or others like it) but not using standard media players.

This allows music distributors to provide promotional music at suitable quality only to permitted DJs that use the vinyl based controller system. These would be users from which the music provider would like feedback. In addition, play data can be sent back from the system to the music providers via the distribution system. The audio track can be distributed legitimately or illegitimately beyond the original system that downloaded the track. However, other media players/users that obtain such a track cannot listen to the higher quality version unless they have the requisite permissions. The music provider can still retain some control over the audio track release.

1. A method of distributing music comprising the steps of:
creating a structured audio file from an audio track, the structured audio file having an audio file format that comprises a non-audio portion and an audio portion, wherein the format is recognisable by a standard media player such that the audio portion is reproducible by a standard media player, the structured audio file comprising:
first data in the audio portion that can be used to reproduce a lower quality version of the audio track by a media player, and
encrypted second data in the non-audio portion that can be used to reproduce a higher quality version of the audio track,
and
wherein the structured audio file is for provision to one or more users having a media player adapted to extract and decrypt the encrypted second data and adapted to reproduce the higher quality version of the audio track from the second data.

2. A method according to claim 1 wherein the non-audio portion of the structured audio file is a metadata portion.

3. A method according to claim 1 wherein the media player is adapted to extract and decrypt the encrypted second data by way of having the requisite permissions.

4. A method according to claim 1 wherein the media player is adapted to extract and decrypt the encrypted second data by way of being operated by a user with requisite permissions.

5. A method according to claim 1 wherein the media player is adapted to extract and decrypt the encrypted second data by way of having the requisite permissions and being operated by a user with requisite permissions.

6. A method according to one of claims 3 to 5 wherein the media player has requisite permissions by having one or more keys for decryption.

7. A method according to one of claims 3 to 5 wherein the user has requisite permissions by having a password that can be supplied to the media player.

8. A method according to claim 1 further comprising receiving the audio track from a third party.

9. A method according to claim 1 wherein one or more of the steps could be conducted on hardware at different locations and/or operated by different entities.

10. A method according to claim 1 further comprising providing the structured audio file to one or more users having a media player adapted to extract and decrypt the encrypted second data and adapted to reproduce the higher quality version of the audio track from the second data.

11. A method according to claim 1 wherein the audio track is a promotional audio track.

12. A method according to claim 1 further comprising the step of receiving data from one or more media players of one or more users, the data representing information relating to playback of the audio track.

13. A method according to claim 1 wherein creating the structured audio file comprises the steps of:
converting the audio track into first data using an encoding regime, the first data defining the audio track in a manner such that the audio track will be reproduced at a lower audio quality by a media player, and
converting the audio track into second data using an encoding regime, the second data defining the audio track in a manner such that the audio track will be reproduced at a higher audio quality by a media player if permission exists, and
encrypting the second data.

14. A method according to claim 1 wherein the structured audio file further comprises an authorised list of users and/or players and/or player types.

15. A method according to claim 1 wherein the encrypted second data comprises a watermark.

16. A method according to claim 1 wherein the structured audio file format is an MP3 format.

17. A method according to claim 1 wherein the audio track is originates from one or more of a/an:
music distributor,
recording company,
record label, and/or
artist.

18. A method according to claim 9 wherein providing the structured audio file comprises providing the file for download by one or more users having a nominated media player adapted to extract and decrypt the second data and adapted to reproduce the higher quality version of the audio track from the second data.

19. A method according to claim 1 wherein a media player not adapted to extract and decrypt the encrypted second data can reproduce a lower quality version of the audio track using the first data in the audio portion.

20. A method according to claim 16 comprising the steps of:
downloading the structured audio file to a media player,
obtaining a decryption key and decrypting the encrypted second data, and
reproducing a higher quality version of the audio track from the second data.

21. A method according to claim 17 further comprising the steps of:
downloading the structured audio file, and
reproducing a lower quality version of the audio track from the first data using a media player.

22. A method according to claim 1 wherein the method is carried out by one or a combination of:
music distributor,
recording company,
record label,
music provider, and/or
third party service.

23. A method of creating a structured audio file for distribution comprising the steps of:
converting an audio track into first data using an encoding regime, the first data defining the audio track in a manner such that the audio track will be reproduced at a lower audio quality by a standard media player, and
converting the audio track into second data using an encoding regime, the second data defining the audio track in a manner such that the audio track will be reproduced at a higher audio quality,
encrypting the second data,
creating a structured audio file having a format that is recognisable by a standard media player, the structured audio file having a non-audio portion comprising the encrypted second data and an audio portion comprising the first data.

24. An apparatus for distributing music, the apparatus being adapted to:
create a structured audio file from an audio track, the structured audio file having a format that comprises a non-audio portion and an audio portion, wherein the format is recognisable by a standard media player such that the audio portion is reproducible by a standard media player, the structured audio file comprising:
first data in the audio portion that can be used to reproduce a lower quality version of the audio track by a media player, and
encrypted second data in the non-audio portion that can be used to reproduce a higher quality version of the audio track,
and
wherein the structured audio file is for provision to one or more users having a media player adapted to extract and decrypt the encrypted second data and adapted to reproduce the higher quality version of the audio track from the second data.

25. An apparatus according to claim 24 wherein the apparatus comprises hardware at different locations and/or operated by different entities.

26. A structured audio file embodying an audio track for distribution, the file having a format that is recognisable by a standard media player and comprising:
an audio portion comprising first data, the first data obtained by converting the audio track using an encoding regime, the first data defining the audio track in a manner such that the audio track will be reproduced at a lower audio quality by a standard media player, and
a non-audio portion comprising encrypted second data, the second data obtained by converting the audio track using an encoding regime, the second data defining the audio track in a manner such that the audio track will be reproduced at a higher audio quality.

27. A method of distributing music comprising a structured audio file comprising an unencrypted low quality audio track in an audio portion and an encrypted high quality audio track in a non-audio portion.
